(19) United States
(12) Patent Application Publication
(10) Pub. No.: US 2004/0054836 A1
(43) Pub. Date: Mar. 18, 2004

(54) Method of data access by simulating an external device to be a hard disk drive

(76) Inventors: Cheng-Shing Lai, Taipei (TW); Xiao-Long Fan, NanJing (CN); Hong-Liang Liu, NanJing (CN)

Correspondence Address: BIRCH STEWART KOLASCH & BIRCH, PO BOX 747, FALLS CHURCH, VA, 22040-0747, US

(21) Appl. No.: 10/245,272

(22) Filed: Sep. 18, 2002

(51) Int. Cl. G06F 13/14

(52) U.S. Cl. 710/305

(57) ABSTRACT

A method of data access by simulating an external device to be a hard disk drive, the method enables an external device to proceed with data exchange directly with a computer. The data access method includes the following steps: firstly, the first operation system of a host detects an external device, and requests for a USB device describer from the external device. Next, the connection relationship between the host and the external device is set up in accordance with the USB device describer. An operation command is sent from the first operation system of the host to the external device, and the second operation system in the external device proceeds with data operation according to the operation command, and sends a completion message back to the host.

### BACKGROUND OF THE INVENTION

1. Field of the Invention

The invention relates in general to a method of data access, and more particularly to a method of data access by simulating an external device to be a hard disk drive.

2. Description of the Related Art

Mobile phones and computers have become essential tools for modern people in trading business or official business. The data interflow or exchange between these two is also very frequent. Traditionally, a specific software is adopted to connect a mobile phone and a computer via a Universal Serial Bus (USB) port. When connecting, it is necessary to install the specific software and the USB driver every time. Then the time consumed when installing would be a waste for those businessmen who believe time is benefit.

### SUMMARY OF THE INVENTION

It is therefore an object of the invention to provide a method of data access by simulating an external device to be a hard disk drive. The method enables an external device to proceed with data exchange directly with a computer, so the install operation is simplified, data access becomes faster and handier, and the product practicability is improved.

The invention achieves the above-identified objects by providing a method of data access by simulating an external device to be a hard disk drive. The method enables an external device to proceed with data exchange directly with a computer. The data access method comprises the following steps: firstly, the first operation system of a host detects an external device, and asks for a USB device describer from the external device. Next, the connection relationship between the host and the external device is set up in accordance with the USB device describer. An operation command is sent from the first operation system of the host to the external device, and the second operation system in the external device proceeds with data operation according to the operation command, and sends a completion message back to the host.

Other objects, features, and advantages of the invention will become apparent from the following detailed description of the preferred but non-limiting embodiments. The description is made with reference to the accompanying drawings in which:

### BRIEF DESCRIPTION OF THE DRAWINGS

FIG. 1 illustrates a block diagram of a data access structure by simulating an external device to be a hard disk drive according to a preferred embodiment of the invention;

FIG. 2A illustrates a system-control diagram in a host end according to a preferred embodiment of the invention;

FIG. 2B illustrates a system-control diagram in an external device end according to a preferred embodiment of the invention;

FIG. 3 illustrates a flow chart of a method of data access by simulating an external device to be a hard disk drive according to a preferred embodiment of the invention;

FIG. 4 illustrates roles of protocols according to a preferred embodiment of the invention;

### DESCRIPTION OF THE PREFERRED EMBODIMENT

A method of data access by simulating an external device to be a hard disk drive according to the invention mainly uses the transport function of the USB Communication Protocol and the USB Mass Storage Class Protocol to enable an external device to become an external hard disk drive of a computer, and to achieve high-speed data exchange and convenient operations for users.

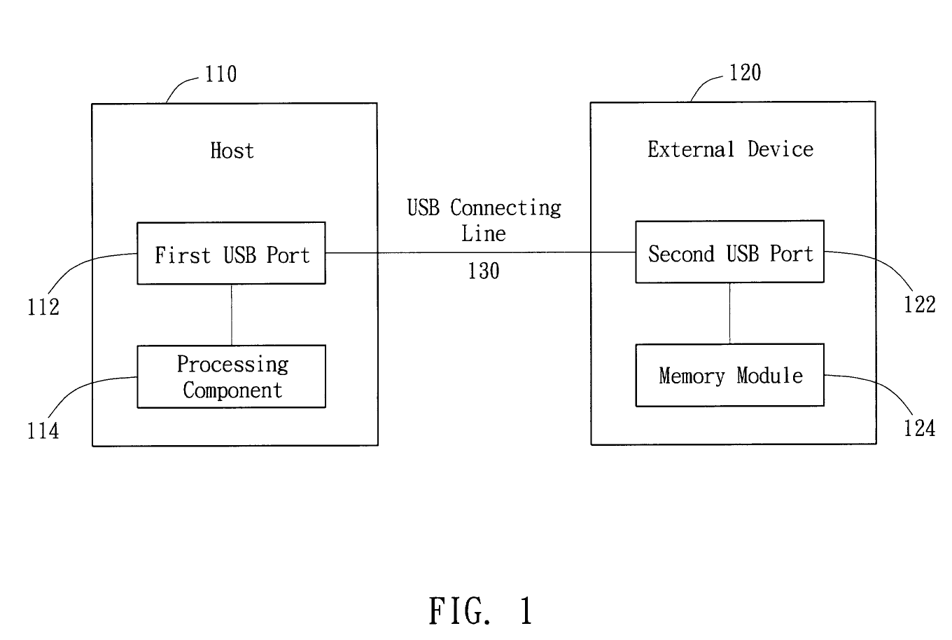

FIG. 1 illustrates a block diagram of a data access structure by imitating an external device to be a hard disk drive according to a preferred embodiment of the invention. A host 110 includes at least a first USB port 112 and a processing component 114; and an external device 120 includes at least a second USB port 122 and a memory module 124. As shown in FIG. 1, a USB connecting line 130 connects the first USB port 112 of the host 110 with the second USB port 122 of the external device 120. After the connection between the host 110 and the external device 120 is built up, the process component 114 of the host 110 can directly access data with the memory module 124 of the external device 120, then the external device can be simulated as an external hard disk drive of the host 110. In addition, the host 110 can be a personal computer, a notebook or other desk top computers; the external device 120 can be a mobile phone or other palm devices, such as a mobile phone with a USB port, which can proceed data exchange with a computer directly.

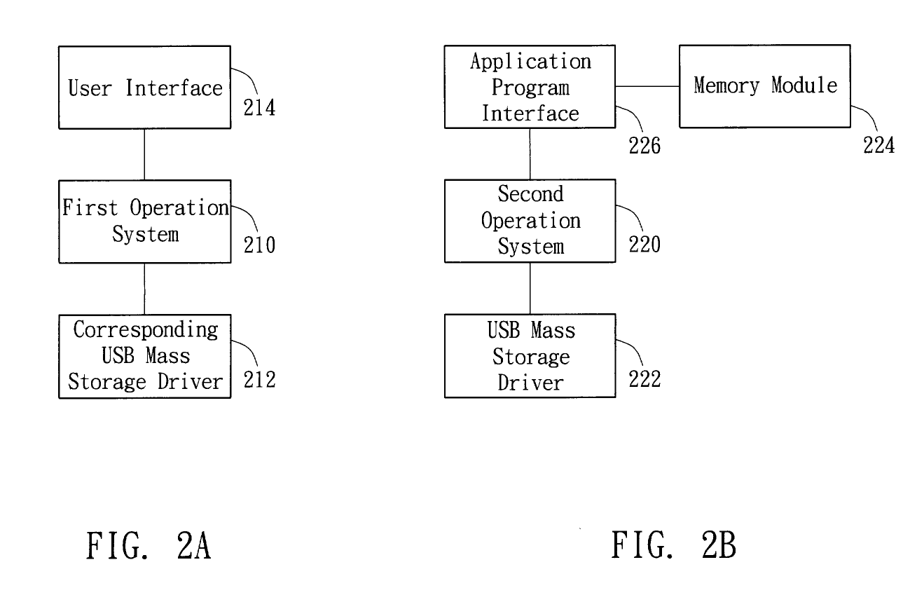

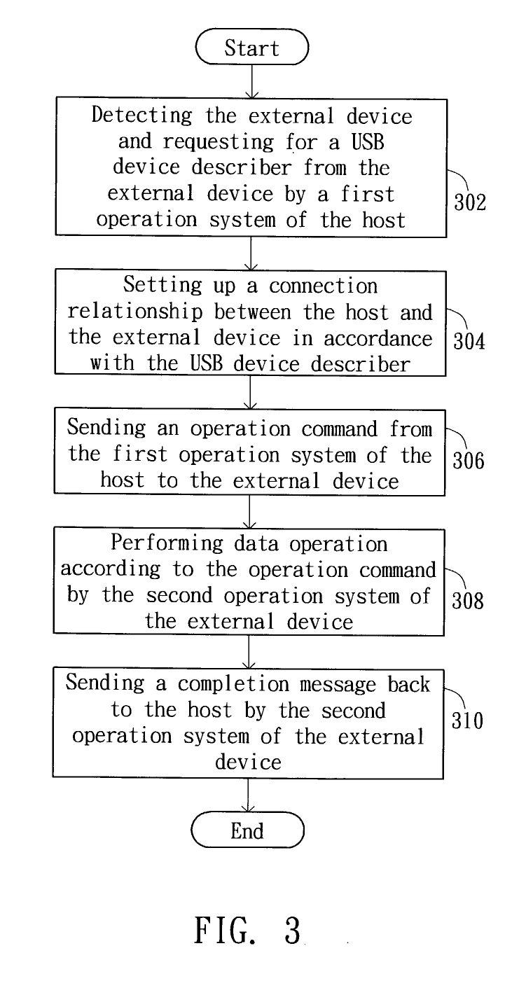

Referring to FIG. 3, a flow chart of a method of data access by simulating an external device to be a hard disk drive according to a preferred embodiment of the invention is illustrated. Please also refer to FIG. 2A and FIG. 2B, which respectively illustrate system-control diagrams in a host end and an external device end according to a preferred embodiment of the invention. As shown in FIG. 3, the method of direct data access and exchange proceeded between the external device 120 and the host 110 is illustrated as follows:

To start with Step 302, the first operation system 210 of the host 110 detects an external device 120 and requests for a USB device describer from the external device 120. The USB device describer is for indicating the characters of the USB external device, such as indications about the product and manufacturer of the external device. Next, at step 304, the connection relationship between the host 110 and the external device 120 is set up in accordance with the USB device describer. Before the connection between the host 110 and the external device 120 is set up, the second operation system 220 of the external device 120 starts a USB Mass Storage Driver 222, and the first operation system 210 of the host 110 loads and starts the corresponding USB Mass Storage Driver 212 after obtaining the USB device describer. After the connection between the host 110 and the external device 120 is set up, a new hard disk drive is shown on a user interface 214 by the first operation system 210, and the data and content of the new hard disk drive can be found on the user interface 214. The first operation system can be a windows operation system while the user interface 214 can be a Windows file manager, for example. Therefore, a user can directly operate and control the external device from the host end.

At step 306, an operation command is sent from the first operation system 210 of the host 110 to the external device 120. At step 308, the second operation system 230 in the external device 120 proceeds with data operation on a memory module 224 via an application program interface 226 according to the operation command. The data operation on the memory module 224 includes to set up a content, to delete a content, to set up a file, to delete a file, to edit and save a file, and so on.

Finally, at step 310, a completion message is sent back to the host 110 after the second operation system 230 of the external device 120 finishes the data operation, then the method of data access is completed.

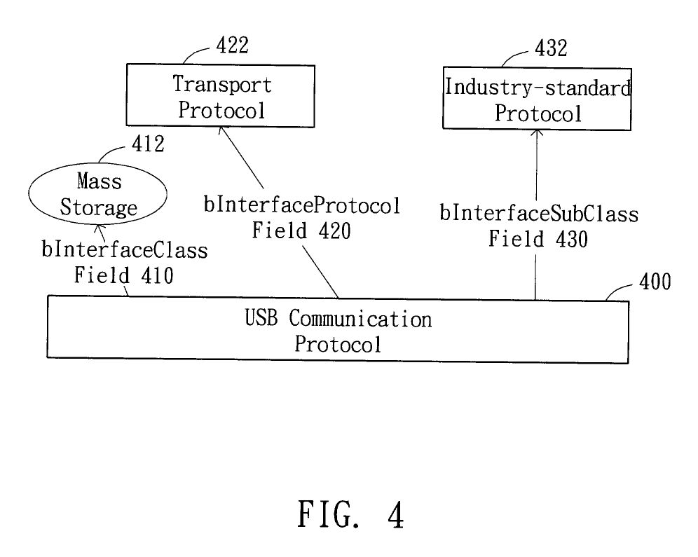

Referring to FIG. 4, roles of protocols according to a preferred embodiment of the invention is illustrated. The USB Communication Protocol 400 is defined for identifying the high-speed communication between the USB external device 120 and the host 110, and the USB Mass Storage Class Protocol is defined for identifying the practice of data exchange operated by the USB Mass Storage under the windows operation system. On the roles of protocols, the fundamental protocol is USB Communication Protocol 400. In the bInterfaceProtocol field 410, the external device 120 via its own device describer informs the host 110 that itself is a Mass Storage 412 and also assigns the Transport Protocol 422 used by the Mass Storage 412 in the bInterfaceProtocol field 420. The Transport Protocol 422 can be Bulk-Only Transport, CBI (Control/Bulk/Interrupt protocol), or other related protocols. In addition, the Industry-standard Protocol 432 for transporting in the Mass Storage 412 is assigned in the bInterfaceSubClass field 430 to perform the data access of the new hard disk drive. The Industry-standard Protocol can be SCSI (Small Computer System Interface) Transport Command Set, or RBC (Reduced Block Commands), UFI, and other related protocols.

As disclosed above, a method of data access by simulating an external device to be a hard disk drive according to the invention, has the following advantages:

1. Fast and convenient data access: by using the principle and protocols of a USB Mass Storage, an external device with a USB port can be simulated to be a hard disk drive for directly proceeding data exchange with a host of a computer. The high-speed and convenient data exchange is therefore achieved.

2. Simplified installation: Under the window operation system for supporting a USB Mass Storage, a file manager can be adopted to directly proceed the data exchange between the external device and the host. No software installation is needed, and no time has to be spent for learning to use the related software. Such an easy operation is very convenient for users, and the practicability of products can then be improved.

3. By changing a palm device to become a USB Mass Storage, a mobile palm device can be simulated to be a portable hard disk drive.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of data access by simulating an external device to be a hard disk drive, wherein the external device can perform data exchange directly with a host, the data access method comprising the steps of:
detecting the external device and requesting for a USB device describer from the external device by a first operation system of the host;
setting up a connection relationship between the host and the external device in accordance with the USB device describer;
sending an operation command from the first operation system of the host to the external device, and
performing data operation according to the operation command and sending a completion message back to the host by the second operation system of the external device.

2. The method of data access according to claim 1, wherein a USB connecting line connects a first USB port of the host with a second USB port of the external device.

3. The method of data access according to claim 1, wherein before said step of setting up the connection between the host and the external device, the method further comprises:
starting a USB Mass Storage Driver by the second operation system of the external device; and
loading and starting a corresponding USB Mass Storage driver according to the USB device describer by the first operation system of the host.

4. The method of data access according to claim 1, wherein after said step of setting up the connection between the host and the external device, the method comprises showing a new hard disk drive on a user interface by the first operation system,

5. The method of data access according to claim 4, wherein the user interface is a windows file manager.

6 The method of data access according to claim 2, wherein the second operation system proceeds with data operation on a memory module of the external device via an application program interface.

7. The method of data access according to claim 1, wherein the external device is a palm device.

8. The method of data access according to claim 1, wherein under a USB Communication protocol, the host is informed that the external device is a Mass Storage via the USB device describer in a bInterfaceClass field.

9. The method of data access according to claim 8, wherein under the USB Communication Protocol, a Transport Protocol applied by the Mass Storage is assigned via the USB device describer in a bInterfaceProtocol field.

10. The method of data access according to claim 8, wherein under the USB Communication Protocol, an Industry-standard Protocol for transporting in the Mass Storage is assigned via the USB device describer in a bInterfaceSubClass field.
